(19) United States
(12) Patent Application Publication
(10) Pub. No.: US 2019/0368519 A1
(43) Pub. Date: Dec. 5, 2019

(54) HYDRAULIC ACTUATOR

(71) Applicant: Airbus Operations GmbH, Hamburg (DE)

(72) Inventor: Tanno Zantz, Hamburg (DE)

(21) Appl. No.: 16/416,919

(22) Filed: May 20, 2019

Related U.S. Application Data
(63) Continuation of application No. PCT/EP2017/079814, filed on Nov. 20, 2017.

(30) Foreign Application Priority Data
Nov. 21, 2016 (EP) 16199878.6

(51) Int. Cl. F15B 15/10; F15B 15/20; F15B 15/14; F15B 15/26

(52) U.S. Cl. CPC F15B 15/10; F15B 15/204; F15B 2211/3058; F15B 15/262; F15B 2211/30505; F15B 15/149

(57) ABSTRACT

A hydraulic actuator including a cylinder housing surrounding a cylinder cavity. A piston is in the cylinder cavity and separates the cylinder cavity into a first and a second pressure chamber. A connection between the first and the second pressure chamber for a hydraulic fluid is provided. A piston rod extends from the piston along an actuation direction. A locking device can be selectively switched between a locking mode and a non-locking mode, wherein in the locking mode the locking device prevents movement of the piston and in the non-locking mode does not prevent movement of the piston. A first arrangement of piezoelectric elements is inside the first pressure chamber which first arrangement of piezoelectric elements is adapted to selectively contract or expand to change the volume of the first pressure chamber occupied by the piezoelectric elements of the first arrangement of piezoelectric elements.

### CROSS-REFERENCE TO RELATED APPLICATIONS

This patent application is a continuation of and claims priority to PCT International Application No. PCT/EP2017/079814 filed Nov. 20, 2017 which claims priority to European Patent Application No. 16199878.6 filed Nov. 21, 2016, the entire disclosures of which are incorporated by reference herein.

### TECHNICAL FIELD

The disclosure herein is directed to a hydraulic actuator comprising a cylinder housing, a piston, a piston rod and a locking device. The cylinder housing surrounds a cylinder cavity. The piston is arranged in the cylinder cavity, separates the cylinder cavity into a first pressure chamber and a second pressure chamber and is movable along an actuation direction. The volume of the first and the second pressure chamber changes when the piston moves along the actuation direction. A connection between the first and the second pressure chamber for a hydraulic fluid is provided. The piston rod extends from the piston along the actuation direction through the cylinder housing to an exterior of the cylinder housing. The locking device can be selectively switched between a locking mode and a non-looking mode. In the locking mode the locking device prevents movement of the piston and in the non-looking mode the locking device does not prevent movement of the piston.

### BACKGROUND

Conventional hydraulic systems of aerospace vehicles are usually supplied with hydraulic fluid from a central hydraulic fluid system. The hydraulic fluid in the central hydraulic fluid system is often pressurized by hydraulic pumps driven by the aerospace vehicle's engines. In recently developed aerospace vehicles such as the Airbus A380 decentralized electrohydraulic actuation systems are used. The decentralized electrohydraulic actuation systems use electric energy generated by generators in the jet engines of the aircraft to locally drive hydraulic pumps for pressurizing a hydraulic fluid. The locally pressurized hydraulic fluid in turn drives a hydraulic actuator. Thereby, extensive hydraulic connections between the jet engines and the hydraulic actuators can be avoided.

A further development of a hydraulic actuator locally generating the hydraulic pressure is disclosed in German patent application DE 10 2005 060 436 A1. Here, the previously external hydraulic pump is included into the piston of a hydraulic actuator. Preferably, piezoelectric elements are integrated into the piston and form the hydraulic pump which moves the hydraulic fluid from one pressure chamber of the cylinder cavity to the other pressure chamber. Such a hydraulic actuator has the advantage that it does not require any external fluid lines.

A hydraulic pump powered by an arrangement or a stack of piezoelectric elements is disclosed in US 2005/0244288 A1. The hydraulic pump comprises a pump housing forming a pump cavity. Inside the pump cavity a stack of piezoelectric elements is arranged. A diaphragm separates the stack of piezoelectric elements from the remainder of the pump cavity which is filled with a hydraulic fluid. The hydraulic fluid further comprises an inlet opening and an outlet opening each equipped with a one-way valve. Upon contraction of the stack of piezoelectric elements hydraulic fluid is sucked into the pump cavity through the inlet opening. When the stack of piezoelectric elements expands, the hydraulic fluid is expelled through the outlet opening.

### SUMMARY

In view of the above it can be considered an object underlying the disclosure herein to provide an improved hydraulic actuator which does not require an external supply of a pressurized hydraulic fluid. In other words, the hydraulic actuator according to the disclosure herein is preferably independent of a central hydraulic system.

The problem is solved by a hydraulic actuator according to disclosure herein. Such a hydraulic actuator additionally comprises a first arrangement of piezoelectric elements arranged inside the first pressure chamber which first arrangement of piezoelectric elements is adapted to selectively contract or expand to change the volume of the first pressure chamber occupied by the piezoelectric elements of the first arrangement of piezoelectric elements.

The hydraulic actuator according to the disclosure herein is, in other words, based on a common hydraulic actuator. It comprises a cylinder housing which in its inside comprises a cylinder cavity to be filled with a hydraulic fluid. The cylinder cavity may, for example, be of cylindrical shape. Inside the cylinder cavity a piston is movably arranged which piston separates the cylinder cavity into a first and a second pressure chamber. As the piston is movably arranged in the cylinder cavity, the first and the second pressure chamber's respective volume is not constant but variable. The piston may, for example, be disc-shaped and is movable along an actuation direction. The actuation direction preferably corresponds to a longitudinal axis of extension of the cylinder cavity.

A piston rod extends from the piston along the actuation direction through the cylinder housing. For example, the piston rod extends from a surface of the piston delimiting the second pressure chamber and protrudes through an aperture in the cylinder housing into the exterior surrounding the cylinder. A seal is provided in the aperture such that no hydraulic fluid may unintentionally evade from the cylinder cavity. In an exemplary preferred embodiment a second piston rod may be provided which extends from the piston in the opposite direction as the previously described first piston rod. Preferably, the piston rods are of identical dimensions in order to provide a synchronizing cylinder.

A connection for a hydraulic fluid is provided between the first and the second pressure chamber. In other words, the first and second pressure chamber can be brought into fluid communication via a connection for hydraulic fluid. The connection between the first and second pressure chambers does not have to be permanent in the sense that hydraulic fluid can flow at any point in time from one of the pressure chambers into the other pressure chamber. Hence, the first and second pressure chambers are not always in fluid communication. It is contemplated that a connection for hydraulic fluid being provided does not require that the connection is open to the hydraulic fluid, i.e., a connection may be available but the hydraulic fluid may not be able to flow from one pressure chamber to the other as it is temporarily closed or shut off. For example, a connection formed by a fluid line may comprise a valve or throttle which can be selectively closed and opened. Hence, the connection is always present but if the valve or throttle arranged in the connection is closed there may be no fluid communication between the pressure chambers.

The hydraulic actuator further comprises a locking device. The locking device comprises a locking mode in which the piston is locked in its present position and cannot move along the actuation direction. When the locking device is in a non-locking mode, the piston is not locked in its position and may move along the actuation direction. The locking device can be selectively switched between the locking mode and the non-locking mode, for example, by a control or control device. The locking device may, for example, be arranged outside the cylinder cavity and maybe adapted to engage the piston rod in the locking mode. Thus, by preventing movement of the piston rod in the locking mode also movement of the hydraulic cylinders piston is prevented or precluded. In the non-locking mode the locking device disengages the piston rod and allows movement of the piston rod and therefore also the piston in the actuation direction.

Finally, the hydraulic actuator according to the disclosure herein comprises a first arrangement of piezoelectric elements arranged inside the first pressure chamber. The arrangement may comprise one or more stacks of piezoelectric elements. By modifying the voltage applied to each of the piezoelectric elements the respective piezoelectric element expands or contracts. By arranging multiple piezoelectric elements in a stack and operating all of the piezoelectric elements in a stack synchronously, the overall distance the arrangement of piezoelectric elements expands or contracts is increased. The first arrangement of piezoelectric elements is in an exemplary preferred embodiment rigidly attached to either the cylinder housing or a surface of the piston delimiting the first pressure chamber. Upon contraction or expansion of the first arrangement of piezoelectric elements the volume of the first pressure chamber occupied by the first arrangement of piezoelectric elements changes.

In operation the cylinder cavity is at least partly filled with a hydraulic fluid. Upon expansion of the first arrangement of piezoelectric elements, these piezoelectric elements occupy more volume and displace the hydraulic fluid in the first pressure chamber. If at the same time the piston is not locked in its position by the locking device, the hydraulic fluid in the first pressure chamber may push the piston in the actuation direction. Hence, after expansion of the first arrangement of piezoelectric elements the overall volume of the first pressure chamber is increased. At the same time, the overall volume of the second pressure chamber is reduced. If the piston is, however, locked in position by the locking device while the first arrangement of piezoelectric elements expands, the hydraulic fluid needs to flow out of the first pressure chamber, for example, into the second pressure chamber or a reservoir for a hydraulic fluid.

When the first arrangement of piezoelectric elements contracts less volume of the first pressure chamber is occupied by the first arrangement of piezoelectric elements. If at the same time the piston is not locked in position by the locking device, the piston may move against the actuation direction such that the overall volume of the first pressure chamber is reduced and the overall volume of the second pressure chamber is increased. On the other hand, if the piston is locked in position by the locking device, more hydraulic fluid needs to flow into the first pressure chamber, for example, from the second pressure chamber or a reservoir of the hydraulic fluid.

As can be taken from the previous considerations incorporating the first arrangement of piezoelectric elements inside the first pressure chamber advantageously places a hydraulic pump directly into the cylinder housing. Hence, no external supply for a pressurized hydraulic fluid is required to operate the hydraulic actuator. Thereby, the overall dimension of the hydraulic system may be reduced. Further, no hydraulic fluid supply lines are required which are heavy and always at risk of being damaged.

In addition, by locating the arrangement of piezoelectric elements directly in the first pressure chamber the effective surface area of the arrangement of piezoelectric elements can be essentially chosen as large as the effective surface area of the piston in the first pressure chamber. The effective surface area is the surface area of the piston or the arrangement of piezoelectric elements projected on a plane extending perpendicular to the actuation direction. Hence, though the overall stroke length of the arrangement of piezoelectric elements may be very small, the volume covered by each expansion or contraction of the first arrangement of piezoelectric elements is maximized.

In a preferred embodiment a first diaphragm is arranged in the first pressure chamber, wherein the first diaphragm separates the first arrangement of piezoelectric elements from a part of the first pressure chamber which can be filled with a hydraulic fluid. In an exemplary preferred embodiment the diaphragm seals the part of the first pressure chamber in which the first arrangement of piezoelectric elements is arranged from the remainder of the first pressure chamber. Thereby, the first diaphragm advantageously protects the piezoelectric elements of the first arrangement of piezoelectric elements from a hydraulic fluid in the cylinder cavity during operation of the hydraulic actuator. Further, the diaphragm advantageously increases the effective surface area of the first arrangement of piezoelectric elements and thereby increase the stroke length of the piston for each expansion or contraction of the first arrangement of piezoelectric elements.

It is further preferred if a second arrangement of piezoelectric elements is arranged inside the second pressure chamber which second arrangement of piezoelectric elements is adapted to selectively contract or expand to change the volume of the second pressure chamber occupied by the piezoelectric elements of the second arrangement of piezoelectric elements. The second arrangement corresponds to the first arrangement of piezoelectric elements in the way it may be embodied and its potential operation.

Using a first and a second arrangement of piezoelectric elements in the first and the second pressure chamber, respectively, of the hydraulic actuator according to the disclosure herein is particularly advantageous if the arrangements cover the same volume during each stroke and are synchronized in such a manner that if one of the arrangements of piezoelectric elements contracts the other arrangement of piezoelectric elements expands and vice versa. Thereby, advantageously the amount of hydraulic fluid displaced in one of the pressure chambers can be received in the other pressure chamber. Further, if the piston is not locked in position by the locking device the additional volume required, for example, in the first pressure chamber for the first arrangement of piezoelectric elements to expand corresponds to the volume not further occupied by the contracting second arrangement of the piezoelectric elements in the second pressure chamber. Hence, the piston can advantageously be moved in the actuation direction without any hydraulic fluid being moved from one of the pressure chambers to the other or without any hydraulic fluid having to be expelled from one of the pressure chambers or pushed into one of the pressure chambers.

Preferably, a second diaphragm is arranged in the second pressure chamber, wherein the second diaphragm separates the second arrangement of piezoelectric elements from a part of the second pressure chamber which can be filled with a hydraulic fluid. The specific embodiments and advantages of the second diaphragm correspond to those of the first diaphragm.

In a preferred embodiment the connection between the first and the second pressure chamber for a hydraulic fluid is provided by one or more internal connections, wherein each internal connection is formed by an aperture in the piston. Using internal connections, for example, in the form of drilling holes in the cylinder bore has the advantage that the hydraulic actuator can be kept compact dimensions. Further, if exclusively internal connections are used, the hydraulic system in the actuator is closed and there are no external fluid lines which reduces the risk of leaks in the hydraulic system supplying the actuator.

Alternatively or additionally the connection between the first and the second pressure chamber for a hydraulic fluid may be provided by one or more external connections, wherein each external connection is formed by a fluid line connecting the first and the second pressure chamber. Using external connections has the advantage that mounting and control of active flow control elements such as valves is considerably easier. Using both internal and external connections is further advantageous as redundancy of the system may be improved.

It is further preferred if each connection between the first and the second pressure chamber for a hydraulic fluid comprises a flow control, for example, in form of a valve for selectively varying the flow of a hydraulic fluid through the respective fluid connection. Providing valves or other flow control for selectively or controllably varying the flow through the connections between the first and the second pressure chamber advantageously allows actively controlling the flow between the first to the second pressure chamber. Thereby, the flow between the first and the second pressure chamber can preferably be selectively shut-off or enabled. For example, when the first arrangements of piezoelectric elements expands for moving the piston in the actuation direction, the flow control of connections enabling flow out of the first pressure chamber are preferably closed. Thereby, the entire hydraulic fluid displaced by the expanding first arrangement of piezoelectric elements is used to push the piston into the actuation direction and none of it is expelled from the first pressure chamber. On the other hand, if the piston is locked in position by the locking device and hydraulic fluid shall be pumped, for example, from the first to the second pressure chamber, the flow connections arranged in the connection enabling flow from the first to the second pressure chamber are preferably wide open to allow a rapid flow from the first pressure chamber to the second pressure chamber.

The valves are preferably active MEMS valves or active one-way disc-valves or magnetorheological valves. MEMS valves and active one-way disc-valves are, for example, described in US 2005/0244288 A1. Magnetorheological valves require the use of a magnetorheological hydraulic fluid and provide particularly fast cycle times between an opened and a closed state.

In an alternative preferred embodiment each connection between the first and the second pressure chamber for a hydraulic fluid is provided with a throttle or a hydraulic screen locally reducing the flow through the respective fluid connection. In this embodiment, switching between pumping hydraulic fluid from one pressure chamber to the other and moving the piston is largely effected by the rate at which the volume of the arrangement of piezoelectric elements changes. Using a throttle or a hydraulic screen instead of an active flow control advantageously reduces the number of movable parts in the hydraulic actuator.

It is further preferred if a hydraulic screen is used in each of the connections between the first and the second pressure chamber for a hydraulic fluid as the flow rate for a hydraulic screen varies with the square root of the pressure difference between the inlet and the outlet of the aperture whereas the flow rate for a throttle changes linearly with the pressure difference between the inlet and the outlet of the throttle.

In a preferred embodiment the connections between the first and the second pressure chamber for a hydraulic fluid are formed by a first set of fluid lines or apertures only enabling a flow of a hydraulic fluid from the first pressure chamber to the second pressure chamber and a second set of fluid lines or apertures only enabling a flow of a hydraulic fluid from the second pressure chamber to the first pressure chamber. Using different connections for the flow of hydraulic fluid from the first pressure chamber to the second pressure chamber than from second pressure chamber to the first pressure chamber advantageously allows the use of controllable check valves or one-way valves. Controllable check valves have a very small response time which in turn allows the use of high frequencies for operation of the arrangements of piezoelectric elements.

In a preferred embodiment the locking device is formed by a multi-disk brake engaging the piston rod. The multi-disk brake is switched between the locking and the non-locking mode by a brake arrangement of piezoelectric elements. The piezoelectric elements of the brake arrangement of piezoelectric elements preferably switch the multi-disc brake via a hydraulic enhancer. Using a brake arrangement of piezoelectric elements preferably allows the brake to switch between a locking and a non-locking mode in a very short time frame. This in turn allows high rates for expanding and contracting the one or more arrangement of piezoelectric elements in the cylinder cavity for achieving larger actuation lengths with the hydraulic actuator in a shorter time span.

In a preferred embodiment the locking device is a hydraulic locking device. The hydraulic locking device is formed by a brake cylinder housing forming a brake cylinder cavity. The piston rod extends along the actuation direction through the brake cylinder cavity. A brake piston is attached to the piston rod, the brake piston being arranged inside the brake cylinder cavity and separating the brake cylinder cavity into a first brake pressure chamber and a second brake pressure chamber. The first brake pressure chamber and the second brake pressure chamber are in fluid connection. Flow control is provided for selectively preventing and enabling flow of a hydraulic fluid between the first and the second brake pressure chamber. Using a hydraulic braking device which essentially operates like a hydraulic actuator has the advantage that the locking device can be switched between the locking and the non-locking mode in the same time frame as the flow control of the hydraulic actuator can be switched between an opened and a closed state. Hence, the rate at which the brake switches between the locking and the non-looking mode does not limit the frequency at which the arrangement of piezoelectric elements used in the hydraulic actuator can be operated.

The hydraulic actuator preferably further comprises a hydraulic fluid reservoir, wherein a connection between the first and/or the second pressure chamber for a hydraulic fluid is provided such that a hydraulic fluid can flow from the hydraulic fluid reservoir to the first and/or the second pressure chamber or from the first and/or the second pressure chamber to the hydraulic fluid reservoir. Using a hydraulic fluid reservoir is the preferred if the hydraulic actuator is a differential cylinder with different effective surface areas of the piston towards the first and the second pressure chamber. Further using a hydraulic fluid reservoir allows operating the hydraulic actuator with one arrangement of piezoelectric elements only.

It is preferred if a third arrangement of piezoelectric elements is arranged inside the hydraulic fluid reservoir for actively providing hydraulic fluid to the first and/or the second pressure chamber or actively removing hydraulic fluid from the first and/or the second pressure chamber. The third arrangement of piezoelectric elements may, for example, be used to operate the hydraulic fluid reservoir essentially as a pump. The third arrangement of piezoelectric elements could move along a housing of the hydraulic fluid reservoir by alternately engaging and disengaging the housing, thereby essentially crawling along the walls forming the housing of the hydraulic fluid reservoir. Such a reservoir is described in US 2007/012968 A1.

In a particularly preferred embodiment the hydraulic actuator further comprises a control. The control is adapted to control the first arrangement of piezoelectric elements and the locking device according to the following sequence of steps: In a first step the locking device is controlled to switch to the non-locking mode, in a second step the first arrangement of piezoelectric elements is controlled to expand such that the volume of the first pressure chamber occupied by the first arrangement of piezoelectric elements is increased, in a third step the locking device is controlled to switch to the locking mode, and in a fourth step the first arrangement of piezoelectric elements is controlled to contract such that the volume of the first pressure chamber occupied by the first arrangement of piezoelectric elements is reduced.

In this preferred embodiment the hydraulic actuator comprises a control, for example, in the form of an integrated circuit such as a microprocessor comprising a memory on which a program code is stored which the program code allows to control the hydraulic actuator according to a predetermined sequence of steps. However, it is also conceivable that instead of using an integrated circuit a hardwired control or an integrated circuit in form of a field programmable gate array (FPGA) is used. Other controls are also conceivable.

The control is adapted for controlling the hydraulic actuator and in particular the first arrangement of piezoelectric elements and the locking device. To this end the necessary connections need to be provided between the control and the elements to be controlled. However, this does not mean that the control necessarily directly interfaces, for example, the arrangement of piezoelectric elements. The control may, for example, control and arrangement of piezoelectric elements by controlling a voltage source which is used to apply a voltage to the piezoelectric elements.

In the first step the locking device is switched by the control into the non-looking mode. Hence, the locking device does not prevent movement of the piston and the piston rod in this position.

In the following second step the first arrangement of piezoelectric elements is controlled to expand such that the volume occupied in the first pressure chamber by the first arrangement of piezoelectric elements is increased. As the piston is not locked in position the hydraulic fluid displaced by the expanding first arrangement of piezoelectric elements may move the piston towards the second pressure chamber such that the volume of the first pressure chamber is increased and the volume of the second pressure chamber is reduced.

The next third step is again used to switch the mode of the locking device: it is now switched into the locking mode such that the piston and the piston rod do not move in the actuation direction.

In the fourth step the first arrangement of piezoelectric elements is now controlled to contract whereby the volume occupied by the first arrangement of piezoelectric elements in the first pressure chamber is reduced. As the position of the piston is kept fixed by the locking device additional hydraulic fluid is to be ingested into the first pressure chamber. Such a hydraulic fluid may, for example, be ingested from the second pressure chamber or a hydraulic fluid reservoir.

After executing all four steps the control may continue operation of the hydraulic actuator by starting again at the first step. The direction of travel of the piston can be reversed by reversing the order of the second step and the fourth step.

In a further preferred embodiment, the control of a hydraulic actuator comprising a second arrangement of piezoelectric elements arranged in the second pressure chamber is further adapted to control the second arrangement of piezoelectric elements. This includes that in the second step the second arrangement of piezoelectric elements is controlled to contract such that the volume of the second pressure chamber is reduced, and that in the fourth step the second arrangement of piezoelectric elements is controlled to expand such that the volume of the second pressure chamber occupied by the second arrangement of piezoelectric elements is increased. In the second step and in the fourth step the first arrangement of piezoelectric elements and the second arrangement of piezoelectric elements are controlled such that during the second and the fourth step the absolute value of the change of volume occupied by the first arrangement of piezoelectric elements over time corresponds to the absolute value of the change of volume occupied by the second arrangement of piezoelectric elements over time.

In this preferred embodiment also a second arrangement of piezoelectric elements is controlled by the control. The control is only adapted to control the second arrangement of piezoelectric elements in the second and the fourth step. In these two steps the second arrangement of piezoelectric elements is controlled to alter its volume in the opposite direction as the first arrangement of piezoelectric element, i.e., in the second step the second arrangement of piezoelectric elements contracts whereas in the fourth step the second arrangement of piezoelectric elements expands. However, within the second and the fourth step the rate at which the first and second arrangement of piezoelectric elements expands or contracts, respectively, is the same. In other words, within each step the additional volume occupied by an expanding first arrangement of piezoelectric elements after a certain time corresponds to the volume not further occupied by a contracting second arrangement of piezoelectric elements after the same time and vice versa.

Further, in a hydraulic actuator comprising in each connection between the first and the second pressure chamber for a hydraulic fluid a flow control, the control is further adapted to control the flow control of each connection between the first and the second pressure chamber for a hydraulic fluid, such that in the first step the flow control are controlled to prevent fluid flow of the first pressure chamber to the second pressure chamber and in the third step the flow control are controlled to enable fluid flow from the second pressure chamber to the second pressure chamber. Note that if two or more elements are controlled in the first and the third step, these elements may be controlled simultaneous or sequentially.

Hence, whenever the locking device is switched into the locking mode, the flow control is set to allow fluid flow between the first and the second pressure chamber, i.e., the first and second pressure chamber are brought into fluid communication. Thus, when movement of the piston is prevented, hydraulic fluid displaced by an expanding arrangement of piezoelectric elements may flow out of the cylinder cavity and voids in the cylinder cavity due to a contracting arrangement of piezoelectric elements can be filled with hydraulic fluid. On the other hand, when the locking device is switched into the non-locking mode, the flow control is set to block any fluid flow between the first and the second pressure chamber or, in other words, the first and second chamber are brought out of fluid communication. Hence, when the movement of the piston is enabled, hydraulic fluid displaced by an expanding arrangement of piezoelectric elements may not flow out of the cylinder cavity but acts entirely on the piston.

In an alternative preferred embodiment of the hydraulic actuator in which each connection between the first and the second pressure chamber for a hydraulic fluid is provided with a throttle or a hydraulic screen locally reducing the flow through the respective connection between the first and the second pressure chamber for a hydraulic fluid, the absolute value of the change of volume occupied by the first arrangement of piezoelectric elements over time in the second step is controlled to be greater than the absolute value of the change of volume occupied by the first arrangement of piezoelectric elements over time in the fourth step.

Due to the use of a throttle or a hydraulic screen in each of the connections between the first and the second pressure chamber for a hydraulic fluid, the amount of fluid flowing through the connections is lower for a full expansion or contraction of the arrangements of piezoelectric elements if the absolute value of the change of volume is greater. A hydraulic screen is understood as a local flow resistance having a length to diameter ratio of less than 1.5. In other words, the higher the rate at which the volume of the arrangements of piezoelectric elements in the pressure chambers changes, the less hydraulic fluid is pushed through the connections for the hydraulic fluid and the more pressure acts on the piston. Hence, in this embodiment the flow rate through the connections is advantageously regulated without requiring any actively controlled flow control.

In an exemplary aspect the problem is solved by a method for operating a hydraulic actuator according to the previously described embodiments. The method comprises a first step in which the locking device is switched to the non-locking mode, a second step in which the first arrangement of piezoelectric elements expands such that the volume of the first pressure chamber occupied by the first arrangement of piezoelectric elements is increased, a third step in which the locking device is switched to the locking mode, and a fourth step in which the first arrangement of piezoelectric elements contracts such that the volume of the first pressure chamber occupied by the first arrangement of piezoelectric elements is reduced.

After executing all four steps the method may continue by starting again at the first step. The direction of travel of the piston can be reversed by reversing the order of the second step and the fourth step.

In a preferred exemplary embodiment, the method is provided for controlling a hydraulic actuator comprising a second arrangement of piezoelectric elements arranged in the second pressure chamber. This exemplary embodiment of the method further includes that in the second step the second arrangement of piezoelectric elements contracts such that the volume of the second pressure chamber is reduced, and that in the fourth step the second arrangement of piezoelectric elements expands such that the volume of the second pressure chamber occupied by the second arrangement of piezoelectric elements is increased.

Another preferred embodiment of the exemplary method includes in the first step preventing prevent fluid flow from the first pressure chamber to the second pressure chamber using flow control arranged in the connection between the first and the second pressure chamber for a hydraulic fluid and in the third step enabling fluid flow from the second pressure chamber to the first pressure chamber using flow control arranged in the connection between the first and the second pressure chamber for a hydraulic fluid. Note that if two or more elements are controlled in the first and the third step, these elements may be controlled simultaneous or sequentially.

In an alternative preferred embodiment of the exemplary method a hydraulic actuator in which each connection between the first and the second pressure chamber for a hydraulic fluid is provided with a throttle or a hydraulic screen locally reducing the flow through the respective connection between the first and the second pressure chamber for a hydraulic fluid is operated. In this exemplary embodiment the absolute value of the change of volume occupied by the first arrangement of piezoelectric elements over time in the second step is greater than the absolute value of the change of volume occupied by the first arrangement of piezoelectric elements over time in the fourth step.

The advantages of the embodiments of an exemplary method according to the disclosure herein correspond to the respective embodiments of the hydraulic actuator operated according to the method and the hydraulic actuator adapted to operate according to the method by suitable control.

### BRIEF DESCRIPTION OF THE DRAWINGS

In the following various exemplary embodiments of a hydraulic actuator according to the disclosure herein and a method for operating a hydraulic actuator according to the disclosure herein will be described with reference to the drawings, wherein:

FIG. 1 shows a first exemplary embodiment of a hydraulic actuator according to the disclosure herein;

FIG. 2 shows a second exemplary embodiment of a hydraulic actuator according to the disclosure herein;

FIG. 3 shows a third exemplary embodiment of a hydraulic actuator according to the disclosure herein;

FIG. 4 shows a fourth exemplary embodiment of a hydraulic actuator according to the disclosure herein;

FIG. 5 shows a fifth exemplary embodiment of a hydraulic actuator according to the disclosure herein;

FIG. 6 shows exemplary expansion and contraction rates of a first and a second arrangement of piezoelectric elements used in the exemplary embodiment of a hydraulic actuator of FIG. 5;

FIG. 7 shows in an exemplary manner the relationship between flow rate through a hydraulic screen and a throttle, respectively, and the pressure difference over the hydraulic screen or the throttle;

FIG. 8 shows a first exemplary embodiment of a locking device for use in a hydraulic actuator according to the disclosure herein;

FIG. 9 shows a second exemplary embodiment of a locking device for use in a hydraulic actuator according to the disclosure herein;

FIG. 10 shows a sixth exemplary embodiment of a hydraulic actuator according to the disclosure herein;

FIG. 11 shows a seventh exemplary embodiment of a hydraulic actuator according to the disclosure herein;

FIG. 12 shows a flow chart for a first exemplary embodiment of a method for operating a hydraulic actuator according to the disclosure herein; and

FIG. 13 shows a flow chart for a second exemplary embodiment of a method for operating a hydraulic actuator according to the disclosure herein.

### DETAILED DESCRIPTION

In the following figures like reference numerals designate like elements.

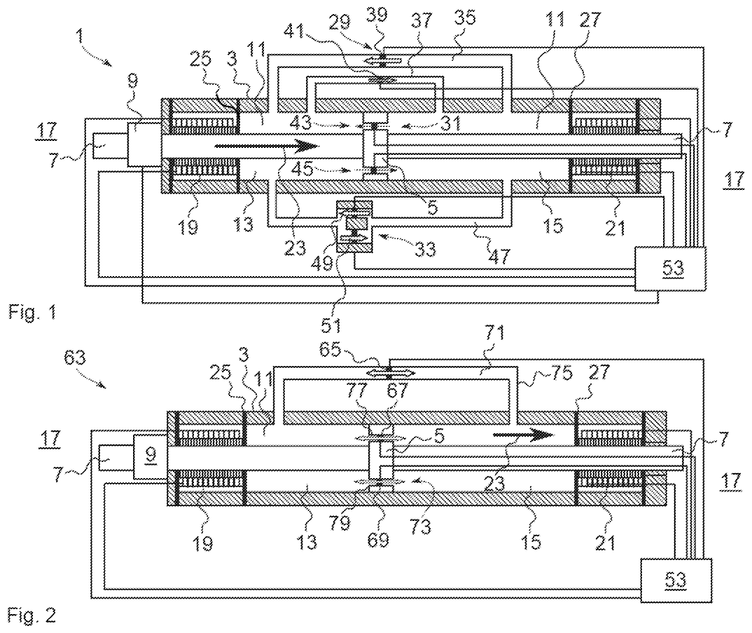

FIG. 1 shows a first exemplary embodiment of a hydraulic actuator 1 according to the disclosure herein. The hydraulic actuator 1 comprises a cylinder housing 3, a piston 5, a piston rod 7 and a locking device 9. The cylinder housing 3 surrounds a cylinder cavity 11 which is separated by the piston 5 into a first pressure chamber 13 and a second pressure chamber 15. In the exemplary embodiment shown in FIG. 1 the hydraulic actuator 1 is a synchronous actuator with the piston rod 7 extending likewise from the surface of the piston 5 facing the first pressure chamber 13 and the surface of the piston 5 facing the second pressure chamber 15. As can be clearly seen in FIG. 1, the piston rod 7 extends through the cylinder housing 3 into the exterior 17 of the hydraulic actuator 1.

The locking device 9 is only shown schematically in FIG. 1. It is adapted to switch between a locking mode and a non-looking mode. In the locking mode the locking device 9 prevents movement of the piston 5 by engaging the piston rod 7. In the non-looking mode the locking device enables movement or does not prevent movement of the piston 5 by disengaging the piston rod 7.

In each of the first and the second pressure chamber 13, 15 a respective first and second arrangement of piezoelectric elements 19, 21 is arranged. Each arrangement of piezoelectric elements 19, 21 is formed by one or more stacks of piezoelectric elements. A stack of piezoelectric elements may comprise a plurality of piezoelectric elements arranged adjacent to one another. When the piezoelectric elements arranged in a stack are operated in a synchronized manner, the entire stack preferably expands or contracts simultaneously. Thereby, the overall distance the stack expands or contracts corresponds to the sum of the individual expansion or contraction of the separate piezoelectric elements.

The first arrangement of piezoelectric elements 19 is arranged in the first pressure chamber 13 and firmly attached to the cylinder housing 3 at an end of the first pressure chamber 13 facing away from the piston 5. In other words in an actuation direction 23 defined by the direction in which the piston 5 is movable in the cylinder cavity 11 the first arrangement of piezoelectric elements 19 is arranged furthest away from the piston 5. A first membrane or diaphragm 25 seals the part of the first pressure chamber 13 in which the first arrangement of piezoelectric elements 19 is arranged from the remainder of the first pressure chamber 13. Thereby, the first arrangement of piezoelectric elements 19 is protected from any hydraulic fluid used for operating the hydraulic actuator 1. When the first arrangement of piezoelectric elements 19 expands, the volume of the first pressure chamber 13 occupied or filled by the first arrangement of piezoelectric elements 19 increases. When the first arrangement of piezoelectric elements 19 contracts, the volume of the first pressure chamber 13 occupied or filled by the first arrangement of piezoelectric elements 19 decreases.

The second arrangement of piezoelectric elements 21 is arranged in a corresponding position in the second pressure chamber 15. Thus, it is firmly attached to the cylinder housing 3 at that end of the second pressure chamber 15 which is furthest away from the piston 5 in the actuation direction 23. A second membrane 27 is provided for separating the second arrangement of piezoelectric elements 21 from the remainder of the second pressure chamber 15 and, in particular, for sealing the second arrangement of piezoelectric elements 21 from hydraulic fluid which is used to operate the hydraulic actuator 1. When the second arrangement of piezoelectric elements 21 expands, the volume of the first pressure chamber 15 occupied or filled by the first arrangement of piezoelectric elements 21 increases. When the second arrangement of piezoelectric elements 21 contracts, the volume of the second pressure chamber 15 occupied or filled by the second arrangement of piezoelectric elements 21 decreases.

The first and the second pressure chamber 13, 15 are connected such that a hydraulic fluid can flow from one pressure chamber 13, 15 to the other pressure chamber 13, 15. In the exemplary embodiment three alternative connections 29, 31, 33 are shown which connect the first and the second pressure chamber 13, 15. The three alternative connections 29, 31, 33 may also be used in combination.

The first connection 29 is an external connection 29 and comprises two fluid lines 35, 37 each comprising an active flow control in form of a one-way valve 39, 41. Thus, if the valve 39 is open a hydraulic fluid may flow from the second pressure chamber 15 through the first fluid line 35 to the first pressure chamber 13. If the valve 39 is closed, no hydraulic fluid can flow through the fluid line 35 from the second pressure chamber 15 to the first pressure chamber 13. As the second fluid line 37 of the first connection 29 comprises a one-way valve 41 which only allows flow of a hydraulic fluid from the first pressure chamber 13 to the second pressure chamber 15, by closing the valve 39 in the first fluid line 35 no hydraulic fluid can flow through the entire first connection 29 from the second pressure chamber 15 to the first pressure chamber 13. On the other hand only if the second valve 41 in the second fluid line 37 is open, a hydraulic fluid may flow from the first pressure chamber 13 through the first connection 29 to the second pressure chamber 15. The external first connection 29 has the advantage that the valves 39, 41 are easily accessible and can be easily maintained.

The second connection 31 is formed by two apertures 43, 45 in the piston 5. Each aperture 43, 45 comprises a valve which is not a designated with a reference numeral to keep the drawing comprehensible. As in the example of the first connection 29, the first aperture 43 comprises an active flow control in form of a one-way valve which only allows flow from the second pressure chamber 15 to the first pressure chamber 13 and blocks flow in the opposite direction. The second aperture 45 also comprises a one way valve, this one only allowing flow from the first pressure chamber 13 to the second pressure chamber 15. Hence, the observations provided with regard to the first external connection 29 also apply to the second internal connection 31 and the apertures 43, 45 providing the internal connection 31. The second internal connection 31 has the advantage that it allows a hydraulic actuator 1 with particularly compact dimensions and no external fluid lines which reduces the risk of loss of hydraulic fluid.

Finally, the third external connection 33 comprises only one fluid line 47. However, the fluid line comprises two parallel active flow control in form of one-way valves 49, 51, each allowing flow only in one direction. Thus, when the one-way valve 49 is open, the third external connection 33 allows flow from the second pressure chamber 15 to the first pressure chamber 13. Only when the second one-way valve 51 is open, hydraulic fluid can flow from the first pressure chamber 13 to the second pressure chamber 15 through the third external connection 33. Such an external connection has the advantage that only two openings in the cylinder housing are required, the valves 49, 51 are easily accessible and the dimensions of the hydraulic actuator 1 can be kept relatively compact.

The valves 39, 41, 49, 51 are preferably selectively operable one-way MEMS-valves, one-way disc valves or magnetorheological valves. All of these valves have the advantages that they can be switched in very short time frames between an opened and a closed state.

Finally, the hydraulic actuator 1 comprises a control 53, for example, in form of a microprocessor with a memory. A program for operating the microprocessor is stored in the memory. The control 53 is functionally connected to all previously described elements of the hydraulic actuator 1 that can be operated: the first and second arrangement of piezoelectric elements 19, 21, the locking device 9 and the valves 39, 41, 49, 51.

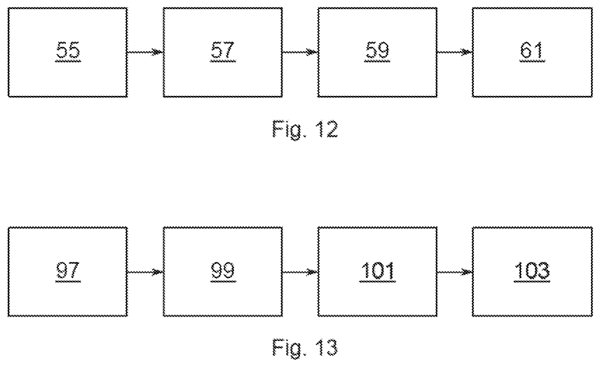

For moving the piston 5 in the actuation direction 23 such that the volume of the first pressure chamber 13 is increased, the control 53 is adapted to control the controllable elements of the hydraulic actuator according to the following method. The steps of operating the control will be described with further reference to the flow chart in FIG. 12.

In a first step 55 the control operates the locking device 9 to switch into the non-locking mode such that the piston 5 and the piston rod 7 are movable in the actuation direction. Further, also in the first step 55 all valves 39, 41, 49, 51 and, in particular, the valves 41, 51 allowing flow from the first to the second chamber are set to a position in which no flow is allowed through the connections 29, 31, 33 from the first to the second pressure chamber 13, 15.

In a second step 57 the first arrangement of piezoelectric elements 19 is controlled to expand. Simultaneously the second arrangement of piezoelectric elements 21 is controlled by the control 53 to contract. The rate at which the first arrangement of piezoelectric elements 19 expands and the second arrangement of piezoelectric elements 21 contracts are preferably chosen such that the absolute change of volume of the respective arrangements of piezoelectric elements 19, 21 over time is the same at any point in time during the second step 57. As the first arrangement of piezoelectric elements 19 expands, the first arrangement of piezoelectric elements 19 occupies more volume of the first pressure chamber 13 and hydraulic fluid in the first pressure chamber 13 is displaced. None of the connections 29, 31, 33 for a hydraulic fluid allows flow of hydraulic fluid out of the first pressure chamber 13. Therefore any displaced hydraulic fluid creates a pressure force acting on the piston 5 and pushing the piston 5 away from the first arrangement of piezoelectric elements 19. Thereby, the overall volume of the first pressure chamber 13 is increased. Simultaneously, the second arrangement of piezoelectric elements 21 contracts such that it fills or occupies less volume of the second pressure chamber 15. As all connections 29, 31, 33 for a hydraulic fluid are closed, no hydraulic fluid can flow into the second pressure chamber 15. Hence, the contracting second arrangement of piezoelectric elements 21 creates a vacuum which pulls the non-locked piston 5 in the actuation direction 23 towards the second arrangement of piezoelectric elements 21.

In a third step 59 the locking device is switched by the control 53 into the locking mode such that the piston 5 and the piston rod 7 cannot move any further in the actuation direction 23. At the same time (though this may happen sequentially) at least those valves 39, 49 of the connections 29, 31, 33 are opened which may allow flow of a hydraulic fluid from the second pressure chamber 15 to the first pressure chamber 13. In other words, after the third step 59 is completed a hydraulic fluid can flow from the second pressure chamber 15 to the first pressure chamber 13.

Finally, in the fourth step 61 the first arrangement of piezoelectric elements 19 is controlled by the control 53 to contract and the second arrangement of piezoelectric elements 21 is controlled by the control 53 to expand. In consequence, the volume occupied by the first arrangement of piezoelectric elements 19 in the first pressure chamber 13 is reduced and the volume occupied by the second arrangement of piezoelectric elements 21 in the second pressure chamber 15 is reduced. Thus, in the first pressure chamber 13 a vacuum is created which is filled by hydraulic fluid from the second pressure chamber 15. Here, the expanding second arrangement of piezoelectric elements 21 displaces hydraulic fluid which is therefore actively pumped through the connection 29, 31, 33 into the first pressure chamber 13. As the piston 5 is locked into position by the locking device 9, any force due to the pressure or vacuum created by one of the arrangements of piezoelectric devices 19, 21 is used to pump hydraulic fluid from one pressure chamber 15 to the other pressure chamber 13.

For further moving the piston 5 in the actuation direction 23, the control 53 and the method may continue at the first step 55.

For moving the piston in the opposite direction essentially the same method can be used with the caveat that the order of the second and the fourth step 55, 61 needs to be reversed, i.e., the control implements a method with the following sequence of steps: first step 55, fourth step 61, third step 59 and second step 57. It is, however, important to note that in the first step 55 all valves 39, 41, 49, 51 are switched to a closed position and in the third steps 59 all valves 39, 41, 49, 51 are switched back to the opened position.

FIG. 2 shows a second exemplary embodiment of a hydraulic actuator 63 according to the disclosure herein. The hydraulic actuator 63 shown in FIG. 2 is similar to the hydraulic actuator 1 is shown in FIG. 1. Thus, in the following only the differences to the hydraulic actuator 1 will be discussed in more detail.

The key difference between the hydraulic actuators 1, 63 of FIGS. 1 and 2 is the use of different valves 39, 41, 49, 51, 65, 67, 69 in the connections 29, 31, 33, 71, 73 between the first and the second pressure chamber 13, 15 for a hydraulic fluid. The valves 39, 41, 49, 51 used in the embodiment shown in FIG. 1 are one-way valves 39, 41, 49, 51. These valves 39, 41, 49, 51 only permit flow of a hydraulic fluid either from the first pressure chamber 13 to the second pressure chamber 13, 15 or in the opposite direction. However, valves 65, 67, 69 used in the connections 71, 73 between the first and second pressure chamber 13, 15 in the second embodiment are two-way valves 65, 67, 69 which permit flow in both directions. This has the advantage, that one connection 71, 73 is sufficient for allowing flow of a hydraulic fluid in both directions.

For example, the embodiment shown in FIG. 2 only comprises an external connection 71 with one fluid line 75 providing a flow path between the first and the second pressure chamber 13, 15 in both directions. Additionally or alternatively the embodiment also comprises an internal connection 73 formed by two apertures 77, 79 in the piston 5. Each of the apertures 77, 79 comprises a valve 67, 69 allowing flow in both directions.

The hydraulic actuator 63 can be operated according to the same method as the actuator 1. Hence, a similarly adapted control 53 can be used to operate the actuator 63

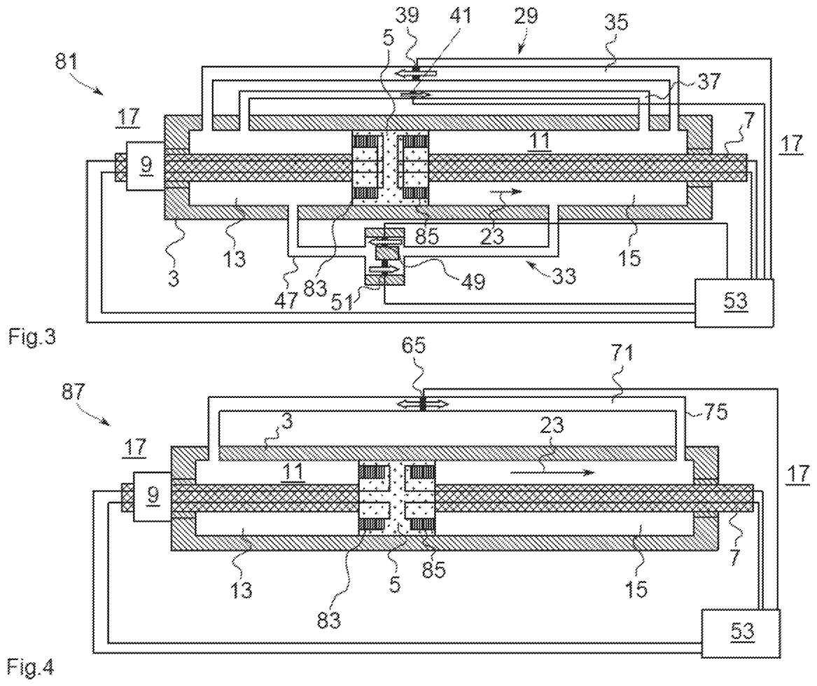

A further exemplary embodiment of a hydraulic actuator 81 according to the disclosure herein is shown in FIG. 3. Again, the features of this hydraulic actuator 81 are very similar to the features of the hydraulic actuator 1 shown in FIG. 1. Thus, only the differences to the preceding embodiment will be described in more detail.

The hydraulic actuator 81 differs from the hydraulic actuator 1 shown in FIG. 1 in that the first and second arrangement of piezoelectric elements 83, 85 are not rigidly attached to the walls of the cylinder housing 3 but instead to the piston 5. Further, as the arrangements of piezoelectric elements 83, 85 take up most of the surface area of the piston 5 towards the first and second pressure chamber 13, 15 the hydraulic actuator 81 does not comprise any internal connections between the first and second pressure chamber 13, 15 for a hydraulic fluid. Instead external connections 29, 31 are provided which are identical to the connections 29, 31 of the exemplary embodiment of a hydraulic actuator 1 shown in FIG. 1.

The hydraulic actuator 81 shown in FIG. 3 is operated in the same manner as the hydraulic actuator 1 shown in FIG. 1. Thus, the control 53 operates according to the same method as previously described.

A fourth exemplary embodiment of a hydraulic actuator 87 is shown in FIG. 4. Again, only the differences to the previously described embodiments will be discussed in more detail.

This embodiment of a hydraulic actuator 87 is based on the embodiment shown in FIG. 3. In fact, it shows a combination of the embodiments of FIG. 3 and FIG. 2 where the arrangement of piezoelectric elements 83, 85 are arranged on the piston 5 as in the embodiment of FIG. 3 and there is only one external fluid line 71 as in the embodiment of FIG. 2. The single external fluid line 71 provides a two-way connection between the first and second pressure chamber 13, 15 for a hydraulic fluid, i.e., the valve 65 is a two-way valve 65.

The embodiment of FIG. 4 is like the previously discussed hydraulic actuators 1, 63, 81 operated using a control 53. The control 53 is adapted to operate the locking device 9, the arrangements of piezoelectric elements 83, 85 and the valve 65 according to the previously described method.

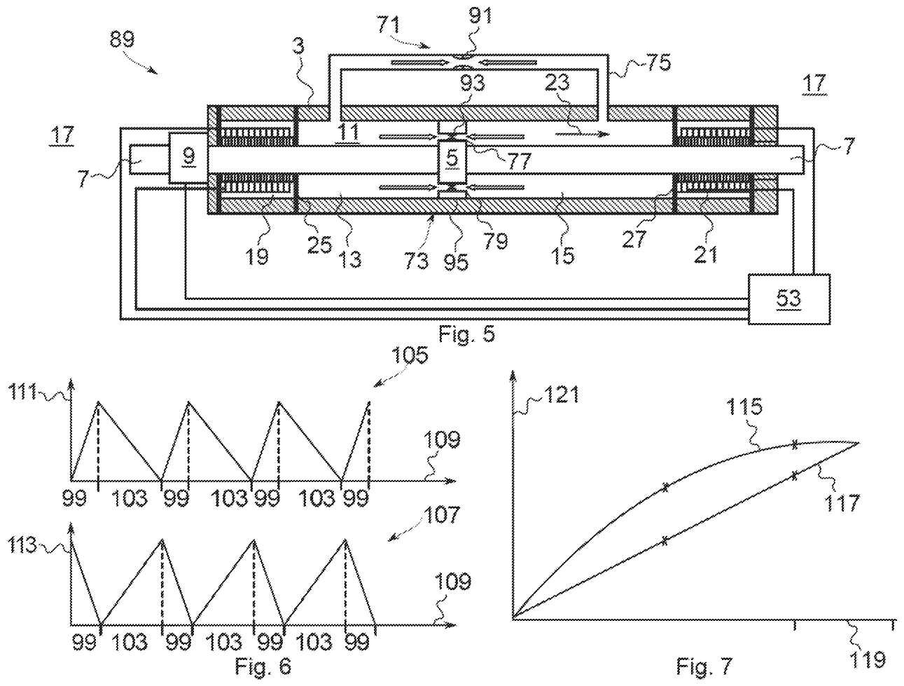

A fifth embodiment of a hydraulic actuator 89 is shown in FIG. 5. This embodiment is based on the exemplary embodiment of a hydraulic actuator 63 shown in FIG. 2. As already practiced with regard to the previous embodiments, only differences to the hydraulic actuator 63 shown in FIG. 2 will be discussed in more detail.

The embodiment of FIG. 5 differs from the embodiment in FIG. 2 in that the valves 65, 67, 69 in the first and second connection 71, 73 between the first and the second pressure chambers 13, 15 for a hydraulic fluid are replaced with throttles 91, 93, 95. In other words, the external fluid line 75 providing the first connection 71 between the first and second pressure chamber 13, 15 of the cylinder housing 3 comprises a throttle 91 which locally limits the cross-section of the fluid line 75. Similarly, in the apertures 77, 79 provided in the piston 5 as internal fluid connection 73 between the first and the second pressure chamber 13, 15 for a hydraulic fluid throttles 93, 95 have been arranged. These throttles 93, 95 locally limit the cross-section of the apertures 77, 79 and reduce the flow through the latter. Using a throttle 91, 93, 95 instead of an active flow control such as a valve advantageously reduces the number of movable parts in the hydraulic actuator 89.

A method of operating the fifth exemplary embodiment of a hydraulic actuator 89 will now be described with reference to FIG. 13. Operation can be effected by implementing in the control 53 the following sequence of method steps, i.e., by adapting the control 53 to operate according to the following method steps. The method described in the following paragraphs is based on the method previously described the reference to FIG. 12. Thus, only the differences to the previously described method will be described in more detail.

The first step 97 corresponds to the first step 55 and the locking device 9 is set into the non-looking mode in which the piston 5 is not locked in position, i.e., once the first step 97 has been completed the piston 5 and the piston rod 7 may freely move in the actuation direction 23. Note that the open cross-section of the throttles 91, 93, 95 is not modified in any of the method steps. Hence, the connections 71, 73 between the first and the second pressure chamber 13, 15 for a hydraulic fluid are permanently kept open in this method, i.e., the first and the second pressure chamber 13, 15 are permanently in fluid communication.

As in the previously described method, in the second step 99 the first arrangement of piezoelectric elements 19 is controlled by the control 53 to expand at a first rate of expansion. Simultaneously, the second arrangement of piezoelectric elements 21 is controlled by the control 53 to contract at a first rate of contraction. A rate of expansion and a rate of contraction both quantify the change of volume occupied by the respective arrangement of piezoelectric elements 19, 21 over time. While a rate of expansion refers to an increase in volume occupied by an arrangement of piezoelectric elements 19, 21, a rate of contraction refers to a reduction in volume occupied by an arrangement of piezoelectric elements 19, 21. In the second step 99, the first rate of expansion corresponds to the first rate of contraction, i.e., the absolute value of the ratio of change in volume over time is the same for the first and the second arrangement of piezoelectric elements 19, 21.

In the third step 101 the locking device 9 is switched into the locking mode such that it prevents any movement of the piston 5 and the piston rod 7 in the actuation direction 23. Again, the open cross-section of the throttles 91, 93, 95 is not modified.

Finally, in the fourth step 103 the first arrangement of piezoelectric elements 19 is controlled by the control 53 to contract at a second rate of contraction. Simultaneously, the second arrangement of piezoelectric elements 21 is controlled by the control 53 to expand at a second rate of expansion. In the fourth step 103 the second rate of expansion corresponds to the second rate of contraction, i.e., the absolute value of the ratio of change of volume over time is the same for the first and the second arrangement of piezoelectric elements 19, 21. The second rate of contraction is smaller than the first rate of contraction and the second rate of expansion is smaller than the first rate of expansion. In other words, in the fourth step 103 the second arrangement of piezoelectric elements 21 expands at a slower rate than the first arrangement of piezoelectric elements 19 in the second step 99. Likewise, in the fourth step 103 the first arrangement of piezoelectric elements 19 contracts at a slower rate than the second arrangement of piezoelectric elements 21 in the second step 99.

This is exemplified in the two graphs 105, 107 shown in FIG. 6. Both graphs 105, 107 show on the abscissa or horizontal axis 109 the time. The ordinate of the top graph 105 shows on the ordinate or vertical axes 111 the volume of the first arrangement of piezoelectric elements 19 and the ordinate of the lower graph 107 shows on the ordinate or vertical axes 113 the volume of the second arrangement of piezoelectric elements 21. On the abscissa 109 reference numerals 99 and 103 indicate which method step is carried out in the respective time sections, i.e., if a section of the abscissa is indicated with reference numeral 99, a second method 99 step is carried out and if a time sections indicated with reference numeral 103, a fourth step 103 is carried out. The two graphs 105, 107 clearly show how in the second method step 99 the respective first rate of expansion or contraction is greater then in the fourth method step 103. Using a smaller rate of expansion/contraction during the fourth step 103 increases the absolute volume of the hydraulic fluid that is pumped from the second pressure chamber 15 to the first pressure chamber 13 compared to as if the same rates would be used in the second and the fourth step.

In a preferred modification of the embodiment of FIG. 5 hydraulic screen with a central opening and a length to diameter ratio of less than 1.5 are used instead of the throttles 91, 93, 95. Replacing throttles by a hydraulic screen (similar to a photographic aperture) has the advantage that the effect of using a slow expansion/contraction rate in the pumping step (fourth step) compared to a higher expansion/contraction rate in the actuation step (second step) for pumping more hydraulic fluid is even more pronounced.

This is underlined by FIG. 7 which shows two graphs 115, 117 representing the flow rates of a hydraulic screen and a throttle as a function of the pressure differential across the hydraulic screen and the throttle, respectively. The ordinate 121 depicts the flow rate ΔV and the abscissa the pressure differential Δp. As can be seen in FIG. 7 graph 115 shows that the flow rate ΔV varies for the hydraulic screen with the square root of the pressure differential Δp whereas it is linear in the pressure differential Δp for the throttle (graph 117).

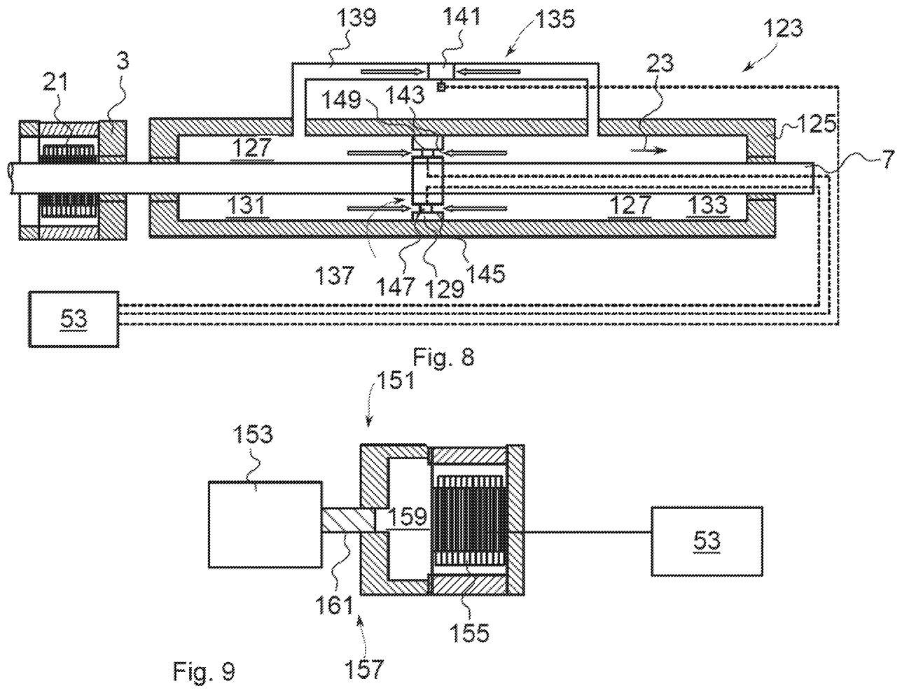

FIG. 8 shows a first exemplary embodiment of a locking device 123 which can be used in a hydraulic actuator 1, 63, 81, 87, 89 according to the disclosure herein. The locking device 123 is a hydraulic locking device 123. It is formed by a brake cylinder housing 125 which forms a brake cylinder cavity 127. The piston rod 7 of the hydraulic actuator 1, 63, 81, 87, 89 extends in the actuation direction 23 through the brake cylinder housing 125. A brake cylinder piston 129 is attached to the piston rod 7 such that it is arranged inside the brake cylinder cavity 127 and separates the letter into a first brake pressure chamber 131 and a second brake pressure chamber 133.

The first and second brake pressure chamber 131, 133 are in fluid connection. In the exemplary embodiment shown in FIG. 8 two different kinds of fluid connections 135, 137 are shown. It is contemplated that these connections 135, 137 can be used alternatively or in combination. The first connection 135 is an external connection comprising a fluid line 139 which provides a connection for a hydraulic fluid between the first brake pressure chamber 131 and the second brake pressure chamber 133. The fluid line 139 comprises a magnetorheological valve 141 for selectively allowing and blocking flow of a magnetorheological hydraulic fluid through the fluid line 139. The second connection 137 is formed by two apertures 143, 145 extending through the brake piston 145. Each aperture 143, 145 provides a connection for a hydraulic fluid between the first and the second brake pressure chamber 131, 133. More or fewer than two apertures 143, 145 can be used. Each aperture 143, 145 comprises a magnetorheological valve 147, 149, where a magnetorheological valve 141, 147, 149 is essentially a way or means for generating a magnetic field that can be selectively turned on or off for interacting with the magnetorheological hydraulic fluid in the brake cylinder cavity 127.

The hydraulic locking device 123 can be switched to a locking mode by closing the magnetorheological valves 141, 147, 149. If the valves 141, 147, 149 are closed. The brake piston 129 cannot move in the brake cylinder cavity 127. However, as the brake piston 129 is rigidly connected to the piston rod 7 of the hydraulic actuator it also prevents movement of the piston 5 of the latter. For switching the hydraulic locking device 123 into a non-looking mode the magnetorheological valves 141, 147, 149 are deactivated such that the hydraulic fluid can freely flow from the first brake pressure chamber 131 to the second brake pressure chamber 133 and back. The hydraulic locking device 123 is preferably controlled using the same control 53 which is also used for operating and controlling the hydraulic actuator 1, 63, 81, 87, 89.

While other valves can be used instead of the magnetorheological valves 141, 147, 149 for operating the hydraulic locking device 123, magnetorheological valves 141, 147, 149 are preferred as they can be switched rapidly between a blocking and a non-blocking setting.

A second exemplary embodiment of a locking device 151 which can be used in a hydraulic actuator 1, 63, 81, 87, 89 according to the disclosure herein is shown in FIG. 9. This locking device 151 is also controlled by the same control 53 that is used to control the hydraulic actuator 1, 63, 81, 87, 89. The locking device 151 comprises a multi-disk brake 153 which directly acts on the piston rod (not shown) of the hydraulic actuator 1, 63, 81, 87, 89. The multi-disc brake 153 is actuated by a brake arrangement of piezoelectric elements 155 which acts on to the multi-disc brake 153 via a hydraulic enhancer 157. The latter is formed by an enhancer cavity 159 filled with a hydraulic fluid acting on an enhancer piston 161 having a reduced cross-section towards the hydraulic fluid as compared to the cross-section of the brake arrangement of piezoelectric elements 155 towards the hydraulic fluid.

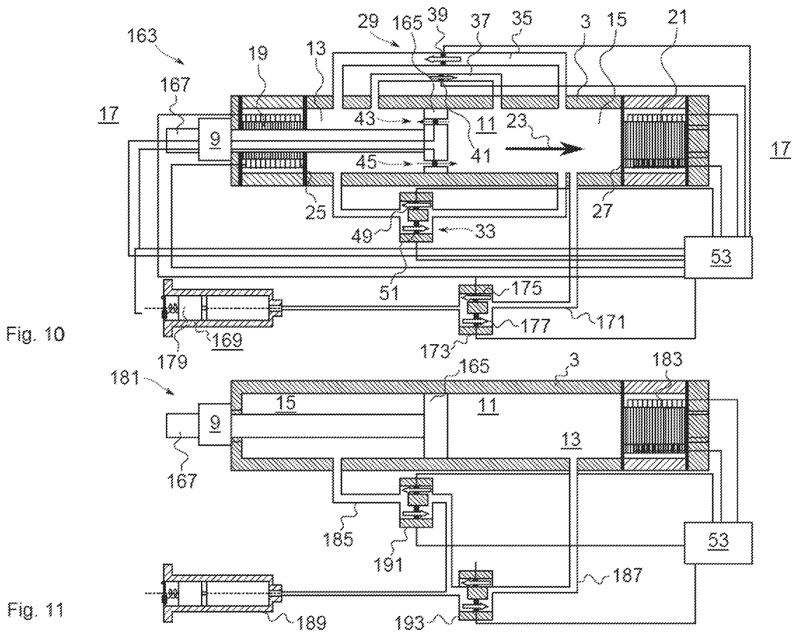

FIG. 10 shows a further embodiment of a hydraulic actuator 163 according to the disclosure herein. The hydraulic actuator 163 is based on the hydraulic actuator 1 shown in FIG. 1. Thus, only the differences as compared to FIG. 1 will be described in more detail.

Other than the hydraulic actuator 1 of FIG. 1 the hydraulic actuator 163 of FIG. 10 is a differential actuator having a piston 165 with different cross-sectional areas towards the first and the second pressure chamber 13, 15. The different cross-sectional areas result from the fact that the piston rod 167 only extends from the piston 165 towards and through the first pressure chamber 13 while there is no piston rod extending through the second pressure chamber 15. In order to have sufficient hydraulic fluid in second pressure chamber 15 when moving the piston 165 towards the first arrangement of piezoelectric devices 19 and for taking up supplemental hydraulic fluid when moving the piston 165 towards the second arrangement of piezoelectric elements 21 a hydraulic fluid reservoir 169 is provided.

The hydraulic fluid reservoir 169 is connected to the second pressure chamber 15 via a fluid line 171. The fluid line 171 comprises a valve arrangement 173 which is made up of two one-way valves 175, 177 which can also be controlled using the control 53. One of the one-way valves 175 enables a flow from the second pressure chamber 15 to the hydraulic fluid reservoir 169 and the other one-way valve 177 only allows flow from the hydraulic fluid reservoir 169 to the second pressure chamber 15. The valve arrangement 173 is controlled such that whenever more hydraulic fluid is required in the second pressure chamber 15 than what can be provided by the first pressure chamber 13 hydraulic fluid is taken from the hydraulic fluid reservoir 169. On the other hand, whenever more hydraulic fluid is to be expelled from the second pressure chamber 15 than what can be taken up by the first pressure chamber 13, this supplemental hydraulic fluid can be pumped to the hydraulic fluid reservoir 169.

The hydraulic fluid reservoir 169 preferably comprises a third arrangement of piezoelectric elements 179 which moves along the wall of the hydraulic fluid reservoir 169 in a crawling manner to change the volume of the hydraulic fluid reservoir 169 and allow it to act like a pump.

Finally, a further differential hydraulic actuator 181 according to the disclosure herein is shown in FIG. 11. Features of this hydraulic actuator 181 which are similarly or identically present in the previous embodiment will not be described in more detail.

Hydraulic actuator 181 differs from all previously described embodiments in that it comprises only a first arrangement of piezoelectric elements 183 but no further arrangement of piezoelectric elements. This first arrangement 183 is arranged in the first pressure chamber 13 of the cylinder housing 3 (note that the first and second pressure chamber are reversed in the drawing as compared to the previously discussed embodiments). The first and the second pressure chamber 13, 15 are both connected via fluid lines 185, 187 to a hydraulic fluid reservoir 189. The hydraulic fluid reservoir 189 is similar to the hydraulic fluid reservoir 169 of the previous embodiment discussed with regard to FIG. 10. In each fluid line 185, 187 a valve arrangement 191, 193 comprising two one-way valves is arranged. The valve arrangements 191, 193 are controlled by the control 53.

The hydraulic actuator 181 is operated in a similar manner as all previous hydraulic actuators 1, 63, 81, 87, 89, 163 with the addition that when the first arrangement of piezoelectric devices 183 expands for moving the piston 165 away from the first arrangement of piezoelectric devices 183, the valve arrangement 191 between the first pressure chamber 13 and the hydraulic fluid reservoir 189 is switched such that hydraulic fluid can be pushed out of the second pressure chamber 15 into the hydraulic fluid reservoir 189. Further, when the first arrangement of piezoelectric devices 183 is controlled to contract for moving the piston 165 towards the first arrangement of piezoelectric devices 183, additional hydraulic fluid needs to be supplied from the hydraulic fluid reservoir 189 to the second pressure chamber 15. In addition, if the first arrangement of piezoelectric devices 183 is controlled to expand for pumping hydraulic fluid out of the first pressure chamber 13, the valve arrangements 193 need to be switched such that the hydraulic fluid can be taken up by the hydraulic fluid reservoir 189.

While at least one exemplary embodiment of the invention(s) herein is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A hydraulic actuator comprising:
a cylinder housing, a piston, a piston rod and a locking device;
wherein the cylinder housing surrounds a cylinder cavity,
wherein the piston is in the cylinder cavity, separates the cylinder cavity into a first pressure chamber and a second pressure chamber and is movable along an actuation direction, wherein a volume of the first and the second pressure chamber changes, when the piston moves along the actuation direction,
wherein a connection between the first and the second pressure chamber for a hydraulic fluid is provided,
wherein the piston rod extends from the piston along the actuation direction through the cylinder housing to an exterior of the cylinder housing, and
wherein the locking device can be selectively switched between a locking mode and a non-locking mode, wherein in the locking mode the locking device prevents movement of the piston and in the non-locking mode does not prevent movement of the piston, and
a first arrangement of piezoelectric elements is inside the first pressure chamber and the first arrangement of piezoelectric elements is adapted to selectively contract or expand to change the volume of the first pressure chamber occupied by the piezoelectric elements of the first arrangement of piezoelectric elements.

2. The hydraulic actuator according to claim 1, wherein a first diaphragm is in the first pressure chamber, wherein the first diaphragm separates the first arrangement of piezoelectric elements from a part of the first pressure chamber which can be filled with a hydraulic fluid.

3. The hydraulic actuator according to claim 1, wherein a second arrangement of piezoelectric elements is inside the second pressure chamber and the second arrangement of piezoelectric elements is adapted to selectively contract or expand to change the volume of the second pressure chamber occupied by the piezoelectric elements of the second arrangement of piezoelectric elements.

4. The hydraulic actuator according to claim 3, wherein a second diaphragm is in the second pressure chamber, wherein the second diaphragm separates the second arrangement of piezoelectric elements from a part of the second pressure chamber which can be filled with a hydraulic fluid.

5. The hydraulic actuator according to claim 1, wherein the connection between the first and the second pressure chamber for a hydraulic fluid are is provided by one or more internal connections, wherein each internal connection is formed by an aperture in the piston, and/or
wherein the connection between the first and the second pressure chamber for a hydraulic fluid is provided by one or more external connections, wherein each external connection is formed by a fluid line connecting the first and the second pressure chamber.

6. The hydraulic actuator according to claim 5, wherein each connection between the first and the second pressure chamber for a hydraulic fluid comprises a flow control for selectively varying a flow of a hydraulic fluid through the respective fluid connection,
wherein the flow control comprises active MEMS valves or active one-way disc-valves or magnetorheological valves.

7. The hydraulic actuator according to claim 5, wherein each connection between the first and the second pressure chamber for a hydraulic fluid is provided with a throttle or a hydraulic screen locally reducing the flow through the respective connection between the first and the second pressure chamber for a hydraulic fluid.

8. The hydraulic actuator according to claim 5, wherein the connections between the first and the second pressure chamber for a hydraulic fluid only are formed by a first set of fluid lines or apertures only enabling a flow of a hydraulic fluid from the first pressure chamber to the second pressure chamber and wherein a second set fluid lines only enabling a flow of a hydraulic fluid from the second pressure chamber to the first pressure chamber.

9. The hydraulic actuator according to claim 1, wherein the locking device is formed by a multi-disk brake engaging the piston rod,
wherein the multi-disk brake is switched between the locking and the non-locking mode by a brake arrangement of piezoelectric elements, wherein the piezoelectric elements of the brake arrangement of piezoelectric elements preferably switches the multi-disc brake via a hydraulic enhancer.

10. The hydraulic actuator according to claim 1, wherein the locking device is a hydraulic locking device,
wherein the hydraulic locking device is formed by a brake cylinder housing forming a brake cylinder cavity, wherein the piston rod extends along the actuation direction through the brake cylinder cavity,
wherein a brake piston is attached to the piston rod, the brake piston being inside the brake cylinder cavity and separating the brake cylinder cavity into a first brake pressure chamber and a second brake pressure chamber,
wherein a connection between the first brake pressure chamber and the second brake pressure chamber for a hydraulic fluid is provided, and
comprising flow control for selectively preventing and enabling flow of a hydraulic fluid between the first and the second brake pressure chamber.

11. The hydraulic actuator according to claim 1, comprising a hydraulic fluid reservoir, wherein a connection between the first and/or the second pressure chamber for a hydraulic fluid is provided such that a hydraulic fluid can flow from the hydraulic fluid reservoir to the first and/or the second pressure chamber or from the first and/or the second pressure chamber to the hydraulic fluid reservoir, and
wherein a third arrangement of piezoelectric elements is inside the hydraulic fluid reservoir for actively providing hydraulic fluid to the first and/or the second pressure chamber or actively removing hydraulic fluid from the first and/or the second pressure chamber.

12. The hydraulic actuator according to claim 1 further comprising a control configured to control the first arrangement of piezoelectric elements and the locking device according to a following sequence of steps:
in a first step the locking device is controlled to switch to the non-locking mode;
in a second step the first arrangement of piezoelectric elements is controlled to expand such that the volume of the first pressure chamber occupied by the first arrangement of piezoelectric elements is increased;
in a third step the locking device is controlled to switch to the locking mode; and
in a fourth step the first arrangement of piezoelectric elements is controlled to contract such that the volume of the first pressure chamber occupied by the first arrangement of piezoelectric elements is reduced.

13. The hydraulic actuator according to claim 12, wherein a second arrangement of piezoelectric elements is inside the second pressure chamber and the second arrangement of piezoelectric elements is adapted to selectively contract or expand to change the volume of the second pressure chamber occupied by the piezoelectric elements of the second arrangement of piezoelectric elements,
wherein the control is further adapted to control the second arrangement of piezoelectric elements,
wherein in the second step the second arrangement of piezoelectric elements is controlled to contract such that the volume of the second pressure chamber occupied the second arrangement of piezoelectric elements is reduced, and
wherein in the fourth step the second arrangement of piezoelectric elements is controlled to expand such that the volume of the second pressure chamber occupied by the second arrangement of piezoelectric elements is increased, and
wherein in the second step and in the fourth step the first arrangement of piezoelectric elements and the second arrangement of piezoelectric elements are controlled such that during the second and the fourth step the absolute value of the change of volume occupied by the first arrangement of piezoelectric elements over time corresponds to the absolute value of the change of volume occupied by the second arrangement of piezoelectric elements over time.

14. The hydraulic actuator according to claim 12,
wherein the connection between the first and the second pressure chamber for a hydraulic fluid are is provided by one or more internal connections, wherein each internal connection is formed by an aperture in the piston, and/or
wherein the connection between the first and the second pressure chamber for a hydraulic fluid is provided by one or more external connections, wherein each external connection is formed by a fluid line connecting the first and the second pressure chamber,
wherein each connection between the first and the second pressure chamber for a hydraulic fluid comprises a flow control for selectively varying a flow of a hydraulic fluid through the respective fluid connection,
wherein the flow control comprises active MEMS valves or active one-way disc-valves or magnetorheological valves,
wherein the control is further adapted to control the flow control of each connection between the first and the second pressure chamber for a hydraulic fluid,
wherein in the first step the flow control is controlled to prevent fluid flow of the first pressure chamber to the second pressure chamber, and
wherein in the third step the flow control is controlled to enable fluid flow from the second pressure chamber to the first pressure chamber.

15. The hydraulic actuator according to claim 12,
wherein the connection between the first and the second pressure chamber for a hydraulic fluid are is provided by one or more internal connections, wherein each internal connection is formed by an aperture in the piston, and/or
wherein the connection between the first and the second pressure chamber for a hydraulic fluid is provided by one or more external connections, wherein each external connection is formed by a fluid line connecting the first and the second pressure chamber,
wherein each connection between the first and the second pressure chamber for a hydraulic fluid is provided with a throttle or a hydraulic screen locally reducing the flow through the respective connection between the first and the second pressure chamber for a hydraulic fluid,
wherein the absolute value of the change of volume occupied by the first arrangement of piezoelectric elements over time in the second step is controlled to be greater than the absolute value of the change of volume occupied by the first arrangement of piezoelectric elements over time in the fourth step.
